(19) United States
(12) Patent Application Publication
(10) Pub. No.: US 2003/0096074 A1
(43) Pub. Date: May 22, 2003

(54) Lint roll and method for making same

(76) Inventor: Su Heon Kim, Palatine, IL (US)

Correspondence Address: PYLE & PIONTEK, Suite 850, 221 N. LaSalle Street, Chicago, IL, 60601, US

(21) Appl. No.: 09/992,450

(22) Filed: Nov. 16, 2001

(51) Int. Cl. A47L 25/08; B32B 33/00

(52) U.S. Cl. 428/40.1; 15/104.002; 428/43; 156/250; 156/289; 156/344

(57) ABSTRACT

The lint roll for removing lint from cloth or clothing comprises a length of tape having a slip element along the length thereof, the length of tape and slip element being wound into a roll and having a full width slit created through the fill thickness of the roll at one circumferential point, in accordance with the method of making the lint roll. The method of using the tape roll is also disclosed.

### FIELD OF THE INVENTION

The present invention is directed to a lint roll and a method for making same. More particularly, the invention relates to a lint roll comprising a roll of adhesive tape wrapped in layers, the roll having a slip element interwrapped between the tape layers, and the roll being slit generally radially through the thickness thereof at one circumferential point, and the method of making same.

### PRIOR ART

Heretofore lint rolls have been proposed in the art. Such lint rolls typically are in the form of a continuous layer of tape wound into a roll which has an exposed outer tacky surface for removing lint from cloth or clothing.

In one prior art embodiment, the length of tape has one side edge area of the tape base, which is not coated with an adhesive, in an attempt to provide a slip area, by means of which an outer layer of the tape can be grasped for removal after the layer is spent. In this embodiment, it has been found that the adhesive tends to spread over the uncoated side edge area, making the layers of tape difficult to separate from each other as the entire width of one layer of the tape roll sticks to the underlying layer. At times, it may be necessary to cut through more than a single layer to finally obtain a “start” for unwinding a spent area of the roll to access an underlying layer, not only taking time but wasting useable layers as well.

The instant lint roll, by the method of making same, avoids such pitfalls.

### SUMMARY OF THE INVENTION

According to the invention there is provided a lint roll comprising a roll of adhesive tape wrapped in layers, said tape roll being slit generally radially through a full thickness thereof at a circumferential point, the slit extending across a width of the tape and a slip element interwrapped between said layers of tape to permit removal of a layer such that once an outer layer is spent, the outer layer is easily removed, by grasping the slip element, starting at said slit and pulling.

Further, according to the invention there is provided a method of making a lint roll comprising at least the steps of:

applying an adhesive to at least a portion of a tape base,

applying a slip element over at least a portion of said tape base, and

winding said tape base with adhesive and said slip element thereon into a roll, and

slitting the roll generally radially from a circumferential point toward the center.

Still further, there is provided a method of using the tape roll comprising the steps of:

determining if the existing outer layer of the roll is no longer effective in removing lint, and if no longer effective;

removing the outer layer of the roll;

using the newly exposed outer layer to remove lint from cloth or clothing; and again removing the outer layer when no longer effective in removing lint.

### BRIEF DESCRIPTION OF THE DRAWINGS

FIG. 1 is a perspective view of the lint roll of the present invention.

FIG. 2 is a perspective view of a layer of tape removed from the lint roll of FIG. 1.

FIG. 3 is an exaggerated cross sectional view through the length of tape comprising the lint roll showing a first embodiment of a slip element provided on the tape of the lint roll.

FIG. 4 is an exaggerated cross sectional view through the length of tape comprising the lint roll showing a second embodiment of a slip element provided on the tape of the lint roll.

FIG. 5 is a perspective view of the lint roll of the present invention showing an outer layer thereof being easily removed.

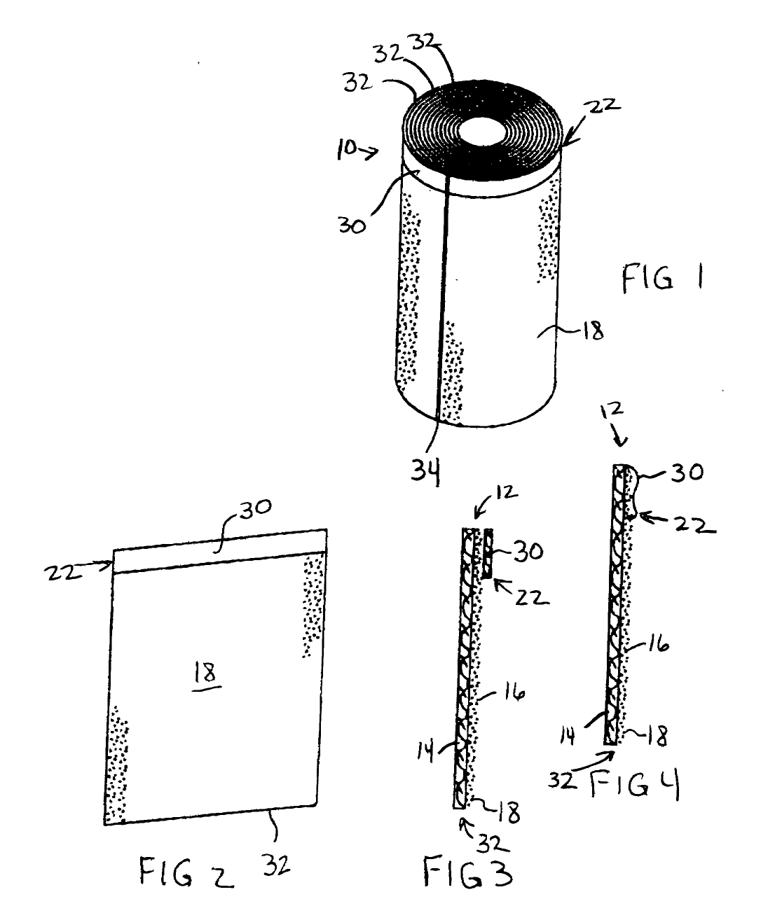

### DESCRIPTION OF THE PREFERRED EMBODIMENT

Referring now to the drawings in greater detail there is illustrated therein a lint roll made in accordance with the teachings of the present invention and generally identified by the reference numeral 10.

As is known in the art, a lint roll 10 comprises a length of tape 12, wound into the roll 10. The tape 12 is comprised of a tape base 14 having an adhesive 16 applied to at least a portion of one surface 18 thereof When wound into a roll 10, the surface 18 of the tape base 14 faces outwardly of the lint roll 10.

In the roll of the present invention, to eliminate sticking together of adjacent wound faces 18 and 20 (see FIG. 5) of the length of tape 12, a slip element 22 is provided. The slip element 22 extends along the length of the tape 12 and is preferably created along one side edge 24 (see FIG. 5) of the tape 12 prior to winding into the roll 10. The slip element 22 can be provided on either surface 18 or 20 of the tape base 14 even though, in the illustrated embodiment, the slip element 22 is preferably provided on the surface 18 having the adhesive 16 thereon.

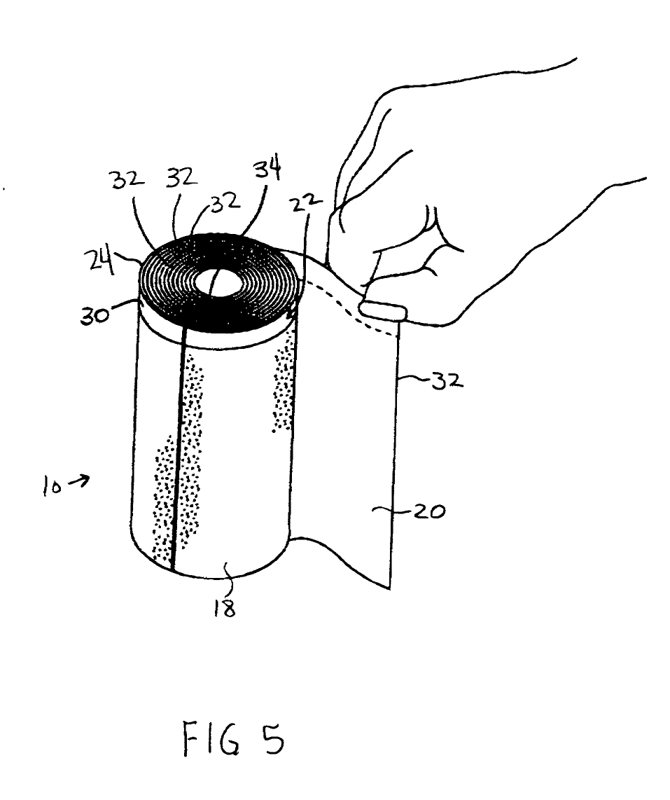

The slip element 22 can be provided in a number of forms. As exemplified in FIG. 3, the adhesive 16 is applied across at least a portion of the width of the tape base 14, and the slip element 22, comprising a nonstick material 30, is applied over the adhesive 16 along the side edge 24, the nonstick material 30 preferably being paper based, such as waxed paper. Alternatively, a nonstick coating 30 can be applied to serve as the nonstick material 30.

The lint roll 10 of the present invention eliminates the need to cut through a plurality of wound layers 32 of tape 12 to provide a starting point when the layers 32 are stuck together. Also, removal of spent layers 32, which has typically required pulling the spent layer 32 away, is eased significantly by providing a slit 34 at a circumferential point, the slit 34 extending generally radially to the center of and across the full width of the roll 10, as well as extending through the full thickness thereof Unlike in the prior art, the slit also extends through the various layers of the slip element.

As best illustrated in FIG. 5, when a user grasps the slip element 22 at a point adjacent the slit 34, peeling away of the outer layer 32 is simply accomplished, saving time as well as decreasing potential waste of the tape 12. Once detached, the outer layer 32 is simply discarded and the underlying layer 32 is instantly ready for use.

In use, the lint roll 10 is rolled along a supporting surface, such as the piece of cloth or clothing, in known manner, until the outer tacky layer 32 is spent, picking up no more lint.

The outer layer 32 is then removed by grasping the slip element 22, adjacent the slit 34, and pulling the outer layer 32 off, around the circumference of the roll 10, exposing an underlying layer 32 for use, until spent.

The above procedure is repeated until all layers 32 of the roll 10 are spent.

As described above, the lint roll 10 of the present invention, and method of making same, provide a number of advantages some of which are enumerated above and others of, which are inherent in the invention. Also modifications may be proposed to the lint roll 10 and method without departing from the teachings herein. Accordingly, the scope of the invention is only to be limited as necessitated by the accompanying claims.

What is claimed is:

1. A lint roll comprising a roll of adhesive tape wrapped in layers, said tape roll being slit through a full thickness thereof at a circumferential point, the slit extending across a width of the tape and a slip element interwrapped between said layers of tape to permit removal of a layer such that once an outer layer is spent, the outer layer is easily removed, by grasping the slip element, starting at said slit and pulling.

2. A lint roll as in claim 1, wherein said slip element is located along one side edge of said roll.

3. A lint roll as in claim 1, wherein said slip element is a nonstick material.

4. A lint roll as in claim 3, wherein said nonstick material is paper based.

5. A lint roll as in claim 1, wherein said slip element is a coating applied to said tape.

6. A lint roll as in claim 5, wherein said coating is a nonstick coating.

7. A lint roll as in claim 6 wherein the slit extends through both the tape and the slip element.

8. A method of making a lint roll comprising at least the steps of:
applying an adhesive to at least a portion of a tape base,
applying a slip element over at least a portion of said tape base, and
winding said tape base with adhesive and said slip element thereon into a roll.

9. A method as in claim 8 further comprising the step of slitting through both the tape base with adhesive and the slip element to form a slit.

10. A method as in claim 8, further comprising the step of creating a full width slit in said roll through a full thickness thereof at one circumferential point.

11. A method as in claim 8, further comprising the step of interwrapping a nonstick material along a side edge of said tape base to create the slip element.

12. A method as in claim 8, further comprising the step of applying a nonstick coating to and along a side edge of said tape base to form said slip area.

13. A method as in claim 8, further comprising the step of gripping the slip element adjacent the slit to remove the outer circumferential layer of tape from said roll.

14. A lint roll comprising a length of adhesive tape wound in layers, said tape roll having a width and a thickness and being slit across a width thereof, through the thickness thereof, at one circumferential point, and including a slip element applied along the length of the adhesive tape.

15. A lint roll as in claim 14, wherein the slit extends through both the tape and the slip element.

16. A method for using a lint roll comprising a length of adhesive tape wound in layers, said tape roll having a width and a thickness and being slit across a width thereof, through the thickness thereof, at one circumferential point, and including a slip element applied along the length of the adhesive tape for removing lint from cloth or clothing comprising the steps of:
determining if the existing outer layer of the roll is no longer effective in removing lint, and if no longer effective;
removing the outer layer of the roll at the slip element;
using the newly exposed outer layer to remove lint from cloth or clothing; and again
removing the outer layer at the slip element when no longer effective in removing lint.

17. A method as in claim 16, wherein the step of removing an outer layer of the roll is accomplished by grasping the slip element, starting at the slit, and pulling off the outer layer of the roll.

18. A method as in claim 16, wherein lint is removed from the cloth or clothing by rolling the outer layer of the roll along the cloth or clothing until the adhesive is no longer capable of collecting any more lint, having become coated with lint and thus, spent.

19. A method as in claim 8, wherein the spent outer layer is removed by grasping the slip element of the spent outer layer, along the slit, and pulling to remove the outer layer to uncover another layer for use 20. A method as in claim 19, wherein the slit is created to extend through both the tape and the slip element.
